(19) United States
(12) Patent Application Publication
(10) Pub. No.: US 2008/0288649 A1
(43) Pub. Date: Nov. 20, 2008

(54) USING PRESENCE PROXIES TO GROUP PRESENCE NOTIFICATIONS

(75) Inventors: ERIK J. BURCKART, Raleigh, NC (US); JOHN P. CAMMARATA, Wake Forest, NC (US); MADHU CHETUPARAMBIL, Raleigh, NC (US); VICTOR S. MOORE, Lake City, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/750,462

(22) Filed: May 18, 2007

(51) Int. Cl. G06F 15/16

(52) U.S. Cl. 709/230

(57) ABSTRACT

The present invention discloses a method and a system for using presence proxies to group presence notifications. In the invention, a presence server can accept, manage, and distribute presence information. Multiple watchers can subscribe to the presence information managed by the presence server. A presence proxy can receive or intercept subscription requests from the watchers, can group these subscription requests, can establish a single subscription between the presence proxy and the presence server for each group of subscription request, can receive notifications form the presence server associated with the single subscription, and can convey received notifications to each of the watchers in a group associated with the single subscription responsive to receiving a corresponding notification from the presence server.

### FIELD OF THE INVENTION

The present invention relates to the field of presence information handling, and, more particularly, to using presence proxies to group presence notifications.

### DESCRIPTION OF THE RELATED ART

A conventional presence server is a physical entity that centrally manages presence information for a set of users and devices to which other users and devices can subscribe. FIG. 1 (Prior Art) illustrates a conventional system 100 that includes a presence server 120. In system 100, a communication node 110 provides presence information to the presence server 120. The communication node 110 can include presentity 112 (e.g., a user) that utilizes a presence user agent 114 (PUA) (e.g., a computer, phone, or other communication device). The presence server 120 can function as a presence agent 122 that handles received presence information and handles subscription requests. Presence information about node 110 can be stored in data store 126 and can be automatically updated when status changes to presentity 112 and/or PUA 114 occur.

One or more clients 120 can utilize a series of watchers 132-136 to subscribe to the presence server 120. Each watcher 132-136 typically corresponds to a particular presentity, such as Presentity A, Presentity B, and Presentity C. When client 130 desires current presence information for Presentity A, a watcher 132 will be established that subscribes to presence information related to Presentity A. Each client 130 can utilize multiple watchers 132-136 to receive presence information for different presentities 112. Multiple clients 130 can concurrently establish different subscriptions for the same presentity 112. Each concurrent subscription with the presence server 120 can increase a load on the server 120. That is, programmatic actions are required by the presence server 120 for each subscription and notification event, which taken together can be CPU and network intensive. Because load on the presence server 120 increases as a number of client 130 subscriptions increases, system 100 can generally have scaling difficulties.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (Prior Art) illustrates a conventional presence system.

FIG. 2 is a schematic diagram of a system for a scalable presence system, where presence proxies group presence notifications in accordance with an embodiment of the inventive arrangements disclosed herein.

FIG. 3 is a flow diagram showing a manner in which presence information is conveyed among clients, a presence proxy, and a presence server in accordance with an embodiment of the inventive arrangements disclosed herein.

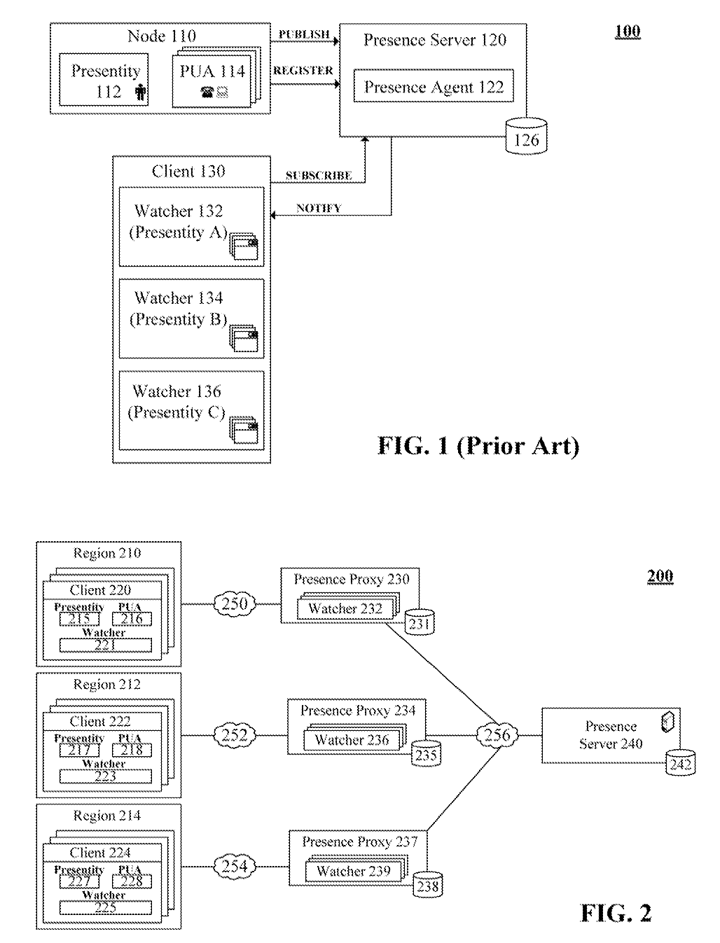

### DETAILED DESCRIPTION OF THE INVENTION

FIG. 2 is a schematic diagram of a system 200 for a scalable presence system, where presence proxies 230, 234, 237 group presence notifications in accordance with an embodiment of the inventive arrangements disclosed herein. In one arrangement, the grouping of notifications can be based at least in part upon a geographical region 210-214 in which clients 220, 222, 224 reside. In other words, each region 210-214 can be associated with a specific presence proxy 230, 234, 237. Each presence proxy 230, 234, 237 can forward publications from clients 220, 222, 224 to the presence server 240. All client subscriptions, which can occur through watchers 221, 223, 225, can be established with a presence proxy 230, 234, 237. The presence proxies 230, 234, 237 can establish subscriptions with the presence server 240 using watchers 232, 236, 239. Accordingly, the presence server 240 need only handle a single subscription for a particular presentity for each region 210-214 regardless of how many clients 220, 222, 224 in each region 210-214 have subscribed to the presentity. In other words, the presence proxies 230, 234, 237 essentially multiplex many subscriptions into a single subscription on a regional or other basis.

As used herein, each client 220, 222, 224 can provide presence information to the presence server 240 and/or can receive presence information from the presence server 240 related to other clients 220, 222, 224. Communication nodes (e.g., clients 220, 222, 224) that convey presence information to the server 220 can each include presentity 215, 217, 227 and one or more presence user agents (PUA) 216, 218, 228. The presentity 215, 217, 227 can provide presence information to a presence service. The presentity 215, 217, 227 can be used to model a presence being exposed and is independent of its manifestation in any user interlace. In practice, the presentity 215, 217, 227 typically is used to uniquely identify a person.

Each PUA 216, 218, 228 can be a means for a principle to manipulate zero or more presentities 212, where a principle is a human, a program, or a collection of users or programs that choose to appear to a presence service (provided by the presence server 240) as a single unique actor distinct from other principles. Typically, the PUA 216, 218, 228 can be a computer, mobile telephone, a mobile computing device, SIP phone, two-way radio, personal data assistant, a client application (e.g., an IM application, a softphone application, etc.) or other computing device that is used by the presentity 215, 217, 227. That is, the presentity 215, 217, 227 can use the PUA 216, 218, 228, which publishes information to the presence server 240 or proxy 230, 234, 237 and/or which registers with the presence server 240 or proxy 230, 234, 237.

The presence server 240 can collect, manage, store, and distribute presence information regarding the access, availability, and willingness to communicate with other users. The presence server 240 can enable the extension of various telecommunication service provider applications and services to include collaboration information and how best to reach people. That is, the presence server 240 provides one or more presence services.

In one embodiment, the presence server 240 can be a stand-alone, carrier-grade, IP Multimedia Subsystem (IMS) compliant server, and the like. In another embodiment, 240 a cluster of servers can be linked to create a single virtual presence server 240. Additionally, the presence server 240 can support standard presence information data format (PIDF) and rich presence information data (RPID). Communications with the presence server 240 can be based on Session Initiation Protocol (SIP) and can conform to Internet Engineering Task Force (IETF) specifications for PUBLISH, SUBSCRIBE, and NOTIFY. Numerous commercial solutions can function as presence servers 240 including, but not limited to the WEBSPHERE presence server, CISCO unified presence server, ORACLE presence server, MICROSOFT OFFICE LIVE COMMUNICATION SERVER, and the like.

The presence proxy 230, 234, 237, can convey PUBLISH requests from clients 220, 222, 224 to the presence server 240 that functions as a presence agent. The presence proxy 230, 234, 237 can also receive SUBSCRIBE requests from clients 220, 222, 224. For each SUBSCRIBE request for a particular presentity a subscription counter can be increased. Therefore, a first SUBSCRIBE request can change the subscription counter from zero to one, which causes the proxy 230, 234, 237 to send a SUBSCRIBE request to the presence server 240. Each time a client 220, 222, 224 UNSUBSCRIBES to a presentity service, the related subscription counter can be decreased by one. When a subscription counter is decreased from one to zero, the proxy 230, 234, 237 can UNSUBSCRIBE to the presence service established between it and the presence server 240. For each presentity service, the proxy 230, 234, 237 can receive notifications from the presence server 240, which the proxy 230, 234, 237 conveys to all subscribing clients 220, 222, 224 in its region.

Each watcher 221, 223, 225, 232, 236, and/or 239 can request presence information about one or more presentity 215, 217, 227 or watcher 221, 223, 225, 232, 236, and/or 239. Special types of watchers 221, 223, 225, 232, 236, and/or 239 can include a fetcher, a poller, and a subscriber, it is possible for a watcher 221, 223, 225, 232, 236, and/or 239 to define which parts of presence information (managed by presence server 240) is received using a set of configurable rules or filters.

The presence proxies 230, 234, 237 and the presence server 240 can each access a data store 231, 235, 238, and 242, within which information can be stored. Data stores 231, 235, 238, and 242 can be a physical or virtual storage space configured to store digital information. Data stores 231, 235, 238, and 242 can be physically implemented within any type of hardware including, but not limited to, a magnetic disk, an optical disk, a semiconductor memory, a digitally encoded plastic memory, a holographic memory, or any other recording medium. Each of the data stores 231, 235, 238, and 242 can be a stand-alone storage unit as well as a storage unit formed from a plurality of physical devices. Additionally, information can be stored within data stores 231, 235, 238, and 242 in a variety of manners. For example, information can be stored within a database structure or can be stored within one or more files of a tile storage system, where each file may or may not be indexed for information searching purposes. Further, data stores 231, 235, 238, and 242 can utilize one or more encryption mechanisms to protect stored information from unauthorized access.

The clients 220, 222, 224, proxies 230, 234, 237, and presence server 240 can he communicatively linked to each other via networks 250, 252, 254, and 256. Each network 250, 252, 254, and 256 can include any hardware/software/and firmware necessary to convey data encoded within carrier waves. Data can be contained within analog or digital signals and conveyed though data or voice channels. The networks 250, 252, 254, and 256 can include local components and data pathways necessary for communications to be exchanged among computing device components and between integrated device components and peripheral devices. The networks 250, 252, 254, and 256 can also include network equipment, such as routers, data lines, hubs, and intermediary servers which together form a data network, such as the Internet. The networks 250, 252, 254, and 256 can also include circuit-based communication components and mobile communication components, such as telephony switches, modems, cellular communication towers, and the like. The networks 250, 252, 254, and 256 can include line based and/or wireless communication pathways.

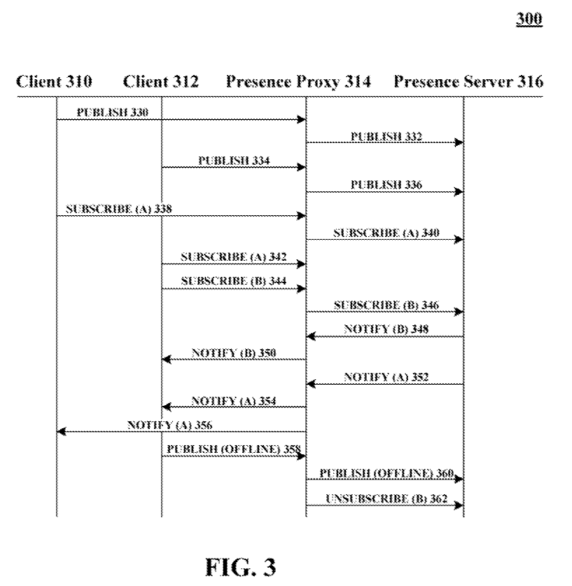

FIG. 3 is a flow diagram 300 showing a manner in which presence information is conveyed among clients 310-312, a presence proxy 314, and a presence server 316 in accordance with an embodiment of the inventive arrangements disclosed herein. The flow diagram 300 can represent messages conveyed between components of system 200 or any similar system that includes a presence proxy 314.

In diagram 300, client 310 can publish 330 presence information (e.g., a SIP PUBLISH message) to the presence proxy 314. The presence proxy 314 can route this information to presence server 316 via another PUBLISH message 332. Client 312 can also publish 334 presence information to the proxy 314, which the proxy 314 publishes 336 to the presence server 316. All client 310-312 specific presence updates can be routed through the presence proxy 314, which forwards them to the presence server 316.

Client 310 can then subscribe 338 to presence information related to Presentity A. The subscription 338 can be conveyed to presence proxy 314, which in turn subscribes 340 for Presentity A information with presence server 316. Client 312 can also subscribe 342 to presence information related to Presentity A by conveying a subscription 342 message to the presence proxy 314.

Since the presence proxy 314 has already subscribed for Presentity A information with the presence server 316 it needs not subscribe again. When the presence proxy 314 receives notifications concerning Presentity A, such as notification 352, the proxy 314 can convey content contained in the notification 352 to both client 310 and 312, as shown by messages 354 and 356.

Client 312 can also subscribe 344 for information related to Presentity B by sending a message 344 to the proxy 314. Upon receiving the message 344, the proxy 314 can subscribe 346 for Presentity B information with the presence server 316. The presence server 316 will then send Presentity B notifications 348 to the presence proxy 314, which conveys an equivalent notification 350 to the client 312.

At some point, client 312 can convey an offline notification 358 to the presence proxy 314 (or the presence proxy 314 can query the client 312 and determine that the client 312 is offline). The presence proxy 314 can publish 360 an offline message to the presence server 316 so that a status of the client 312 can be updated. The presence proxy 314 can maintain a subscription for Presentity A information, since client 310 is still online and has subscribe for presence information related to Presentity A. No online client has subscribed with the presence proxy 314 for information related to Presentity A. The presence proxy 314 can, therefore, UNSUBSCRIBE 362 to the Presentity B information.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A presence system comprising:
a presence server configured to accept, manage, and distribute presence information;
a plurality of watchers configured to subscribe to the presence information managed by the presence server; and
a presence proxy configured to receive subscription requests from the plurality of watchers, to group these subscription requests, to establish a single subscription between the presence proxy and the presence server for each group of subscription requests, to receive notifications from the presence server associated with the single subscription, and to convey received notifications to each of the watchers in a group associated with the single subscription responsive to receiving a corresponding notification from the presence server.

2. The presence system of claim 1, wherein communications between the presence server and the presence proxy and the watchers and the presence proxy use Session Initiation Protocol (SIP) based messages in conformance with an open communication standard.

3. The presence system of claim 2, wherein the open standard is an Internet Engineering Task Force (IETF) based standard, and wherein the presence server provides operations for PUBLISH, SUBSCRIBE, and NOTIFY.

4. The system of claim 1, wherein the presence server and the presence proxy supports standard presence information data format (PIDF) and rich presence information data (RPID).

5. The system of claim 1, wherein each of the plurality of watchers are grouped in accordance with a common geographic region.

6. The system of claim 1, wherein the presence proxy is one of a plurality of presence proxies, each of which handles presence information for a related set of watchers.

7. The system of claim 6, wherein each set of watchers is established based upon a geographical region in which the watchers are located.

8. A method for handling presence information comprising:
a presence proxy receiving SUBSCRIBE requests from a plurality of different clients for a common presentity;
the presence proxy conveying a single SUBSCRIBE request for the common presentity to a presence server;
the presence server establishing a subscription with the presence proxy for the common presentity:
the presence server conveying a NOTIFY message to the presence proxy in accordance with the established subscription; and
the presence proxy conveying a plurality of NOTIFY messages to each of the different clients responsive to receiving the NOTIFY message from the presence server.

9. The method of claim 8, wherein communications between the presence server and the presence proxy and between the presence proxy and the different clients use Session Initiation Protocol (SIP) based messages in conformance with an open communication standard.

10. The method of claim 8, wherein said steps of claim 8 are steps performed automatically by at least one machine in accordance with at least one computer program having a plurality of code sections that are executable by the at least one machine, said at least one computer program being stored in a machine readable memory.

11. A method of disseminating presence notifications comprising:
a plurality of clients conveying subscriptions to a presence proxy, wherein each of the subscriptions is for receiving presentity information associated with a common presentity;
the presence proxy conveying a single subscription to a presence server, wherein said single subscription is for receiving presentity information associated with the common presentity;
the presence server conveying a first presence notification concerning the common presentity to the presence proxy; and
responsive to receiving the first presence notification, the presence proxy conveying a second presence notification to one of the clients and conveying a third presence notification to another one of the clients, wherein content of the first, second, and third presence notifications is the same.

12. The method of claim 11, wherein each of the clients comprises at least one watcher, each watcher being associated with a subscription for a presence service provided by the presence server.

13. The method of claim 12, wherein the presence proxy comprises at least one watcher, each watcher being associated with a subscription for a presence service provided by the presence server.

14. The method of claim 11, wherein the presence server is configured to accept, manage, and distribute presence information using Session initiation Protocol (SIP) based messages and in conformance with an Internet Engineering Task Force (IETF) based standard, and wherein the presence server provides operations for PUBLISH, SUBSCRIBE, and NOTIFY.

15. The method of claim 11, wherein messages conveyed between the clients and the presence proxy and between the presence proxy and the presence server conform to a standardized presence information format, wherein the standardized presence information format is at least one of a presence information data format (PIDF) and rich presence information data (RPID) format.

16. The method of claim 11, wherein the clients comprise at least one presence user agent (PUA).

17. The method of claim 16, wherein the PUA is at least one of a telephone device, a computer, a mobile computing device, and a software application.

18. The method of claim 11, wherein the plurality of clients are located in a common geographic region, wherein different presence proxies handle different sets of clients based upon a geographic region of each of the different sets of clients.

19. The method of claim 11, further comprising:
each of the plurality of clients publishing its own presence information to the presence proxy; and
the presence proxy forwarding the published presence information to the presence server.

20. The method of claim 11, wherein said steps of claim 11 are steps performed automatically by at least one machine in accordance with at least one computer program having a plurality of code sections that are executable by the at least one machine, said at least one computer program being stored in a machine readable memory.
